(19) United States
(12) Patent Application Publication
(10) Pub. No.: US 2005/0118902 A1
(43) Pub. Date: Jun. 2, 2005

(54) Air-cooled diesel outboard motor

(76) Inventor: Boris Kunc, Ljubljana (SI)

Correspondence Address: King & Jovanovic, PLC, 170 College Avenue, SUITE 230, HOLLAND, MI, 49423, US

(21) Appl. No.: 10/499,488

(22) PCT Filed: Dec. 11, 2002
(86) PCT No.: PCT/SI02/00028

(30) Foreign Application Priority Data
Dec. 20, 2001 (SI) P-200100324

(51) Int. Cl. F02B 61/04

(52) U.S. Cl. 440/89 A

(57) ABSTRACT

The-air cooled diesel outboard motor is an outboard motor for boats, which for the driving engine, instead of existing solutions, uses an air-cooled diesel engine with a vertical crankshaft.

This invention concerns an air-cooled outboard motor for boats with a diesel engine with a vertical crankshaft.

This invention is a solution to many technical problems. It significantly unburdens the environment, uses less fuel and can even be used in running waters, whereas water-cooled outboard motors are not appropriate to use in some running waters due to high content of sand in such waters.

The known solution of an air-cooled outboard motor is a two-stroke petrol outboard motor, which makes it inappropriate to use in inner waters of some countries due to environmental regulations.

The solution of the diesel outboard motor is shown as an outboard diesel motor which is water-cooled and is because of this heavy in weight (approx. 100 kg). It is for this reason not convenient for smaller boats and for use in sandy waters (for example the river Pad in Northern Italy contains so much sand that the water pumps fail quite fast).

With this invention the described problem is solved with an air-cooled diesel outboard motor, which weight is comparable to the weight of petrol outboard motors. The motor is composed of an air-cooled diesel engine with a vertical crankshaft and shaft for outboard motors with a gearing ratio and water pump in the lower unit, water-cooling exhalation port and fastened mechanism for the boat. Industrial air-cooled diesel engine with a vertical crankshaft is attached to the shaft of the outboard motor and the vertical crankshaft along with the gear is connected to the axle. To achieve optimal engine power of the propeller it is required to adequately adjust the gearing ratio in the gearbox in relation to the size or propeller gradient. The exhausting port from the power engine connects to the exhausting port in the shaft in a known manner that is with a water-cooled pipe through which the cooling-water flows. Cooling-water flowing is regularly created with a junction on the water pump of the lower unit or also without a built-in water pump but by using propelling power to push the water into the port, which is built-in next to the propeller on the lower part of the anticavitation plate.

1. Air-cooled diesel outboard motor
characterized by
that it is an air-cooled diesel engine with a vertical crankshaft with screwing fastened to an adapted fastening plate of modified existing realization of a complete shaft of an outboard motor with a propeller gradient adjusted gearing ratio in the gearbox, where with the clutch in a known manner vertically connects the crankshaft of the engine with a driving axle in the shaft and through a water-cooled element in a known manner diverts exhaust from the motor into the shaft.
